(19) United States
(12) Patent Application Publication
(10) Pub. No.: US 2016/0026881 A1
(43) Pub. Date: Jan. 28, 2016

(54) LATERAL OBSTACLE DETECTION APPARATUS FOR A MOTOR VEHICLE, MOTOR VEHICLE COMPRISING THAT APPARATUS AND PROCESS FOR DETECTING LATERAL OBSTACLES DURING THE TRAVEL OF A MOTOR VEHICLE

(71) Applicant: VISLAB S.R.L., Parma (PR) (IT)

(72) Inventors: ALBERTO BROGGI, PARMA (IT); STEFANO DEBATTISTI, VOLTA MANTOVANA (IT); MATTEO PANCIROLI, VETTO D'ENZA (IT); PAOLO GRISLERI, ROVELETO DI CADEO (IT)

(21) Appl. No.: 14/452,804

(22) Filed: Aug. 6, 2014

(30) Foreign Application Priority Data
Jul. 22, 2014 (IT) PR2014A000052

(51) Int. Cl. G06K 9/00; H04N 7/18; H04N 13/04

(52) U.S. Cl. CPC G06K 9/00805; H04N 13/0445; H04N 7/181

(57) ABSTRACT

A lateral obstacle detection apparatus (1) for a motor vehicle (100), comprising:
at least a pair of stereo cameras (2, 3) for acquiring images;
a unit (4) for processing the acquired images,
a support (6) for the stereo cameras (2, 3), which has an elongated shape and extends prevalently along a pre-established direction (A) that is substantially perpendicular to a surface (P) on which the vehicle rests (100), the stereo cameras (2, 3) being mounted on the support (6) at different heights (h1, h2) relative to the resting surface (P) and comprising coplanar sensors (5) arranged perpendicularly to the resting surface (P).

### FIELD OF THE INVENTION

The present invention relates to a lateral obstacle detection apparatus for a motor vehicle, a motor vehicle comprising that apparatus and a process for detecting lateral obstacles during the travel of a motor vehicle.

### BACKGROUND OF THE INVENTION

The main field of application of the invention is the automotive industry. In particular, the proposed apparatus and process enable lateral obstacles to be detected during travel in a straight line, or at an intersection or in a roundabout, or during parking manoeuvres.

In the automotive industry artificial vision techniques for locating lateral obstacles are already known and are divided essentially into two categories: monocular techniques and stereoscopic techniques.

Monocular techniques employ a single camera to acquire images.

A first monocular technique is based on the extraction of significant elements or features within the image. Such significant features, which must be easily detectable within the image, are tracked to verify whether they belong to objects in motion. In this manner it is possible to locate and estimate the direction of motion of the vehicles.

This first monocular technique is known in the art with the expression “feature tracking”. One of the drawbacks of feature tracking lies in the necessity of exactly knowing the movement of the vehicle in which the vision system is installed. Moreover, it is indispensable to be able to distinguish static objects from the ground and slow moving objects from stationary ones, as well as correctly recognize the shape of the obstacle. A second monocular technique, known in the art by the expression “flow motion”, is based on comparing frames to detect the variation in the position of obstacles and determine their shape.

The main limit of this technique is tied to the difficulty of discriminating, within the image, nearby obstacles that exhibit similar movements, even if the obstacles are located at different distances. Furthermore, the flow motion technique is cumbersome from a computational standpoint.

A third monocular technique, known in the art by the expression “pattern recognition”, makes use of models or descriptions or groups of features, processed so as to identify parts of the vehicle, for example the front part or rear part of the vehicle.

The pattern recognition technique is however less applicable for recognizing lateral portions of vehicles due to the large variability in the shape of the latter.

Unlike monocular techniques, stereoscopic techniques employ two cameras to acquire information (i.e. images) of an object from two different viewpoints. The distance between the stereoscopic apparatus and the object is then calculated by searching for corresponding points in the two images and by subsequent triangulation using known algorithms.

The precision of stereoscopic techniques decreases, however, in the event of low light. In the case of both monocular and stereoscopic techniques, several cameras are installed on the vehicle in an equal number of positions.

For example, FIGS. 1 to 4 illustrate a vehicle, indicated with the number 100, on which a camera, indicated with the number 2, is installed respectively on the roof (FIG. 1), near the front wheel arch (FIG. 2), in front of the front bumper (FIG. 3) and behind the windscreen (FIG. 4). In each figure from 1 to 4, the field of view (FOV) of the camera 2 is moreover schematically illustrated.

In the automotive sector, various solutions for locating obstacles at the front or rear are known from patent literature.

For example, document U.S. Pat. No. 7,266,454 describes an apparatus and a method for detecting obstacles in a forward zone by using cameras and a radar/laser unit placed in the front part of the vehicle.

Document U.S. Pat. No. 8,588,029 describes an obstacle detection system made up of sonar devices installable in the front or rear zone of a vehicle. This system is capable of determining the distance, direction and shape of an obstacle.

Document U.S. Pat. No. 6,363,326 describes a system for identifying obstacles in the blind spot of a vehicle's side mounted mirrors.

It is well known, in fact, that side mounted mirrors make it possible to verify the approach of obstacles (e.g. other vehicles) in adjacent lanes, but are not capable of covering the whole side rear zone. That is, there are blind spots that cannot be monitored.

For the detection of obstacles in blind spots, document U.S. Pat. No. 6,363,326 describes a plurality of active sensors placed on the side mirrors or in proximity to the latter. These are sensors of the “laser scanner” type, which emit light and calculate the distance as a function of the time-of-flight.

Also known in the automotive sector is the use of stereoscopic apparatus to assist in driving or parking or opening a vehicle door. For example, in document EP2579231, reference is made to a stereo pair made up of cameras placed horizontally side by side, and which are positioned on the doors of a vehicle so as to be able to verify whether there is sufficient room to open the doors and allow the driver and/or passenger to get out.

Document EP1087257, on the other hand, presents a stereo system capable of filming an object situated in front of a vehicle. The cameras making up the system (main camera and sub-camera) are mounted on a support located inside the vehicle near the rear-view mirror.

The use of a stereo pair made up of a main camera and a second camera to detect forward obstacles is also disclosed in US 2008/0199069.

In the system for detecting objects and people described in U.S. Pat. No. 7,652,686, the cameras are placed on the roof and adjustably oriented so as to detect forward obstacles.

In the solution illustrated in US 2013/0342658, the cameras are installed inside the vehicle, on on the rear of the windscreen.

In the solutions just mentioned the amount of components to be installed on board the vehicle is considerable, so the system is invasive and complex. In particular, the lateral installation of cameras poses significant problems of integration.

Furthermore, these solutions are not suitable for use at considerable speeds under low-light conditions. Increasing the exposure time under low-light conditions makes the images blurry due to the movements (referred to in the sector as “motion blur”). This problem affects the lateral zones of the vehicle above all, as they do not benefit from the illumination of the headlights or tail lights. Keeping the exposure time brief attenuates the blur but dark images are obtained and the algorithms give unsatisfactory results.

In this context, the technical task at the basis of the present invention is to propose a lateral obstacle detection apparatus for a motor vehicle, a motor vehicle comprising that apparatus and a process for detecting lateral obstacles during the travel of a motor vehicle which overcome the aforementioned drawbacks of the prior art.

### SUMMARY OF THE INVENTION

In particular, it is an object of the present invention to propose a lateral obstacle detection apparatus and process for a motor vehicle which enable the position of the obstacles to be accurately established even under low-light conditions.

Another object of the present invention is to provide a lateral obstacle detection apparatus for a motor vehicle which is compact, reliable, easy to maintain and not invasive for the vehicle.

Another object of the present invention is to propose a lateral obstacle detection apparatus and process for a motor vehicle which is capable of capturing images of good quality, i.e. not distorted, even at high vehicle speeds.

A further object of the present invention is to propose a motor vehicle which is capable of detecting lateral obstacles and establishing their position with precision even under low-light conditions.

The stated technical task and the specified objects are substantially achieved by a lateral obstacle detection apparatus for a motor vehicle, comprising:
at least one pair of stereo cameras for acquiring images;
a unit for processing the acquired images;
a support for said stereo cameras, said support having an elongated shape and extending prevalently along a pre-established direction that is substantially perpendicular to a surface on which the vehicle rests, said stereo cameras being mounted on the support at different heights relative to said resting surface and comprising coplanar sensors arranged perpendicularly to the resting surface.

Preferably, the camera sensors are substantially rectangular and oriented in such a way as to have the longer sides lying along a direction of forward travel of the vehicle on the resting surface.

In one embodiment, the sensors are of the CMOS type. In another embodiment, the sensors are of the CCD type.

Preferably, the sensors acquire the images according to the global shutter technique.

Preferably, the height difference between said cameras is comprised between 100 mm and 500 mm.

Preferably, the processing unit is configured to perform a rectification, a distortion correction and a disparity calculation on the acquired images.

The stated technical task and the specified objects are substantially achieved by a motor vehicle comprising:
a lateral obstacle detection apparatus as described above;
a compartment for housing the support, which is obtained in proximity to a side of the vehicle, said support being arranged in the housing compartment in such a way that said pre-established direction is substantially perpendicular to the surface on which the vehicle rests;
a bodywork provided, on said side, with at least one through opening for access to the housing compartment.

Preferably, the support is rotatably pivoted on the bodywork in such a way as to rotate around a rotation axis parallel to the pre-established direction so as to vary the overall orientation of the pair of stereo cameras.

In a first embodiment, the through opening consists in a substantially rectangular cut made in the bodywork of the vehicle.

In one embodiment, the through opening is made between the front wheel fender and the front door.

In another embodiment, the through opening is made in proximity to the rear wheel.

In a further embodiment, the through opening is made on a door.

In another embodiment, the through opening is made in proximity to one of the headlights or tail lights.

In one embodiment, the bodyworks presents a single recess obtained in correspondence to the through opening (that is also single). Said recess houses both stereo cameras.

In that embodiment, the vehicle is provided with a grille removably applied to the through opening to mask it, while the cameras are hanging-over mounted relative to the grille.

In another embodiment, the bodywork presents two through openings for access to the housing compartment, which are obtained on the same side of the vehicle. The bodywork also presents two recesses, each of which is obtained in correspondence to one of said through openings and houses one of said stereo cameras.

Preferably, each of the two recesses is substantially shaped as a “drop” with a depth that decreases from the front zone to the rear zone of the vehicle.

The stated technical task and the specified objects are substantially achieved by a process for detecting lateral obstacles during the travel of a motor vehicle, comprising the following steps:
arranging a pair of stereo cameras at different heights relative to the surface on which the vehicle rests, inside a housing compartment in proximity to a side of the vehicle;
periodically acquiring frames of the lateral area of the vehicle by means of the stereo cameras;
processing the acquired images to pinpoint the position of the lateral obstacles.

### BRIEF DESCRIPTION OF THE DRAWINGS

Additional features and advantages of the present invention will be more apparent from the approximate, and thus non-limiting, description of a preferred but not exclusive embodiment of a lateral obstacle detection apparatus for a motor vehicle, a motor vehicle comprising that apparatus and a process for detecting lateral obstacles during the travel of a motor vehicle, as illustrated in the appended drawings, in which:

FIGS. 1 to 4 schematically illustrate a vehicle equipped with a camera in an equal number of positions, according to the prior art;

FIG. 5 illustrates a motor vehicle, according to the present invention, in a first embodiment, in lateral view;

FIG. 6 illustrates the vehicle of FIG. 5, wherein part of the bodywork has been removed to show the housing compartment, in top view;

FIG. 7 is a simplified block scheme of a lateral obstacle detection apparatus for a motor vehicle, according to the present invention;

FIG. 8 illustrates the support and the cameras of the detection apparatus of FIG. 7, in a schematic lateral view;

FIG. 9 illustrates a detail (through opening and grille) of the vehicle of FIG. 5;

FIG. 10 illustrates the support of the detection apparatus of FIG. 7, in perspective view;

FIGS. 11A, 11B, 11C illustrate one of the recesses shaped as a “drop” obtained in the lateral bodywork, respectively in a section view, top view and lateral view;

FIG. 12 illustrates the arrangement of the sensors of the cameras of the detection apparatus of FIG. 7, placed in a two-dimensional cartesian reference coordinates;

FIGS. 13 to 16 illustrate as many embodiments of the vehicle of FIG. 5, in lateral view;

FIG. 17 illustrates the vehicle of FIG. 13, in front view;

FIG. 18 illustrates the images acquired by the sensors of the cameras of the detection apparatus of FIG. 7, placed in cartesian coordinates (X, Y).

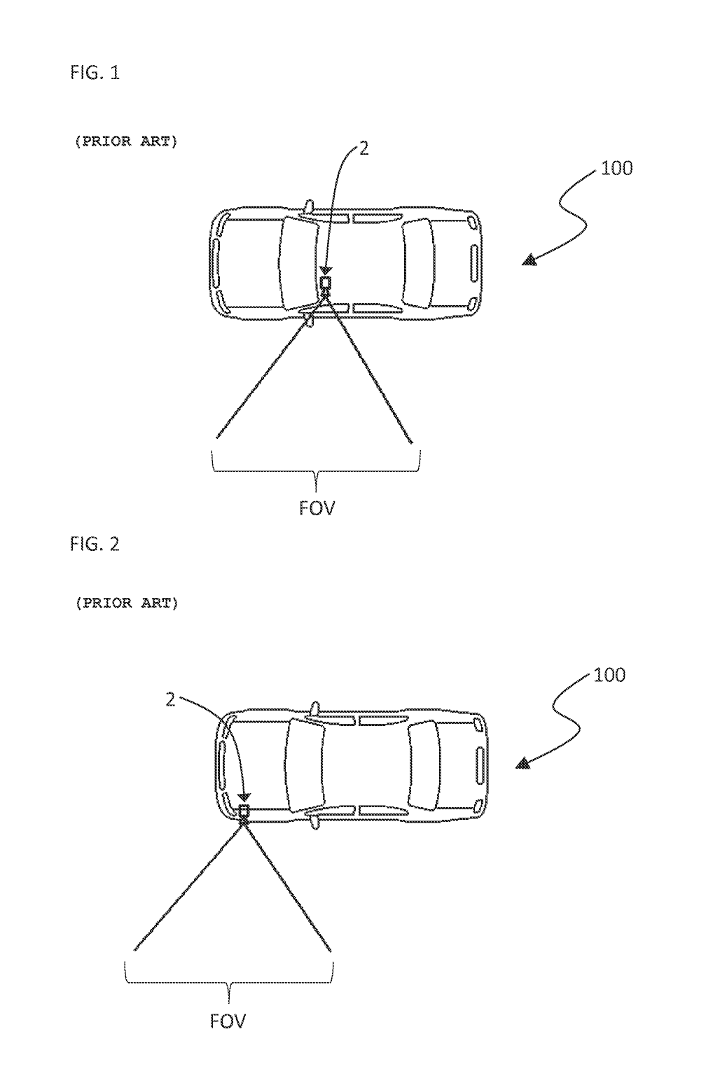

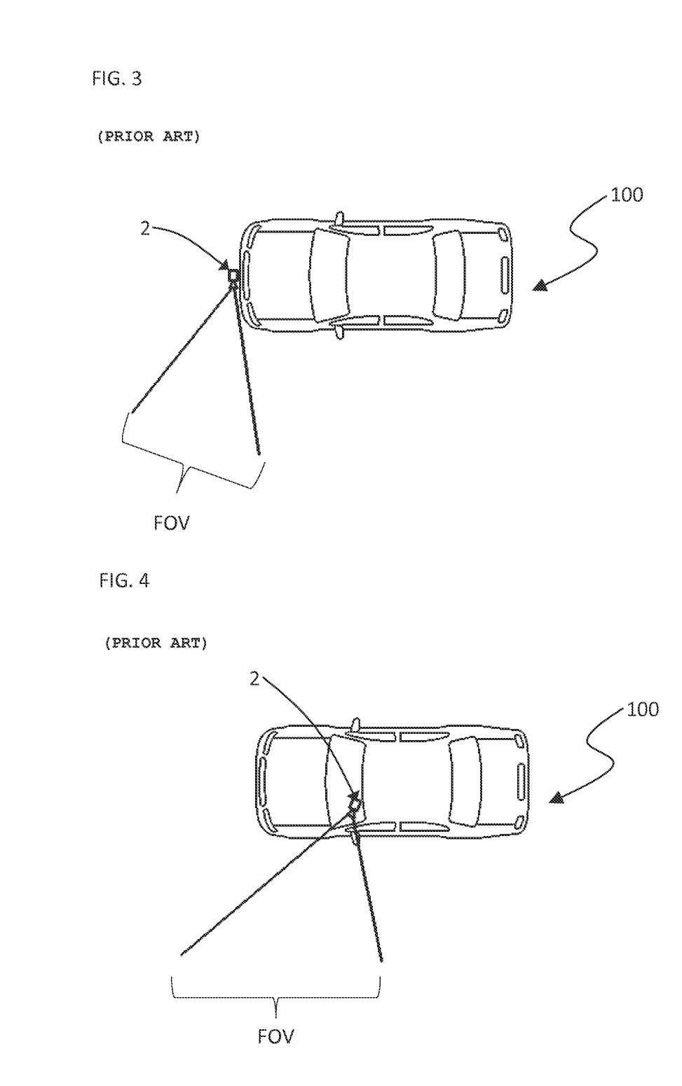

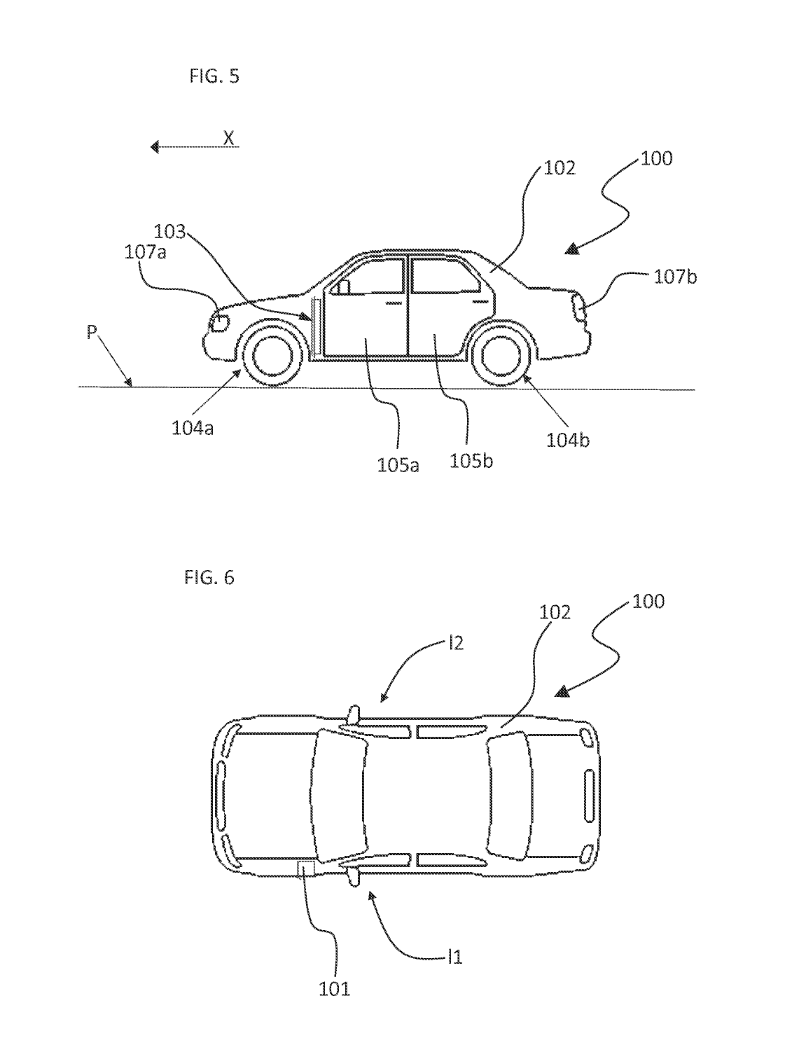

### DETAILED DESCRIPTION OF PREFERRED EMBODIMENTS OF THE INVENTION

With reference to the figures, the number 1 indicates a lateral obstacle detection apparatus for a motor vehicle 100, such as, for example, a car, a bus, a lorry, a road tractor, a lorry and trailer, an articulated vehicle, a farm machine, a work vehicle, a self-propelled vehicle, etc.

In all of the figures appended here, the vehicle 100 is always shown on a substantially horizontal resting surface P. However, the resting surface P could have a different, variable slope depending on the ground to be travelled over.

Considering a generic vehicle 100, the term “sides” of the vehicle means the two lateral body panels thereof. In particular, depending on the type and model of the vehicle 100, each side (or body panel) is partially occupied by one or two doors. Hereinafter, the two sides of the vehicle 100 will be indicated as I1 and I2.

In this context, the term “obstacle” means both a fixed obstacle (e.g. pole, guardrail, Jersey barrier, stationary vehicle) and a moving obstacle (e.g. another vehicle, a pedestrian, etc.).

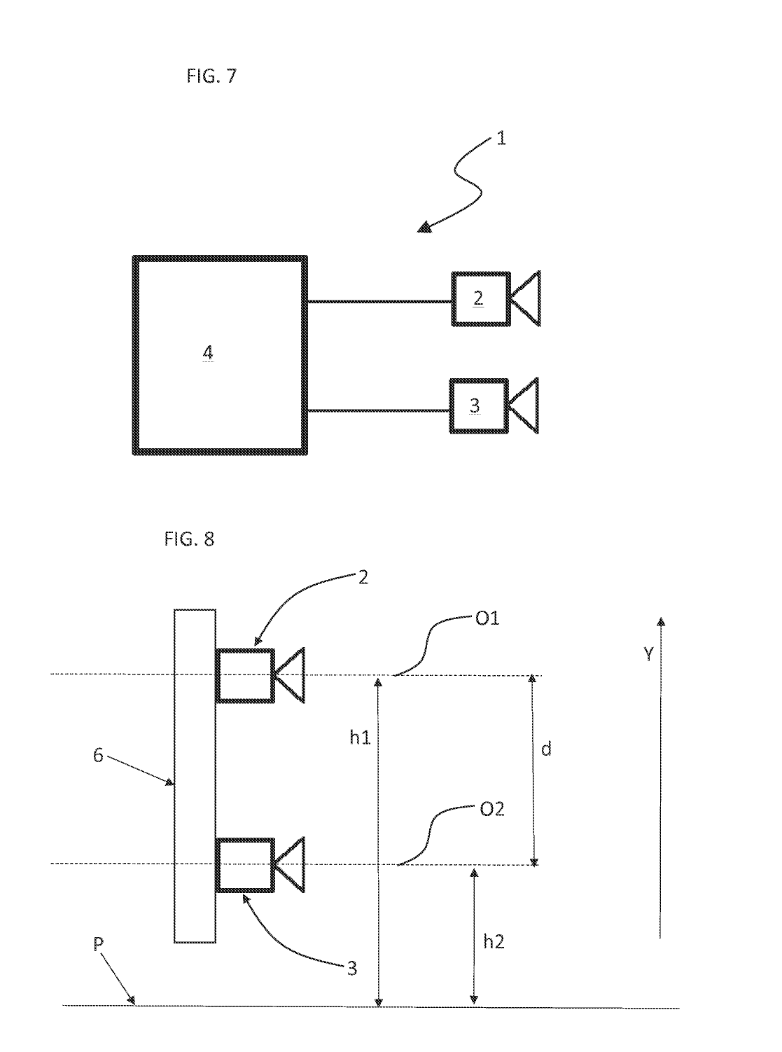

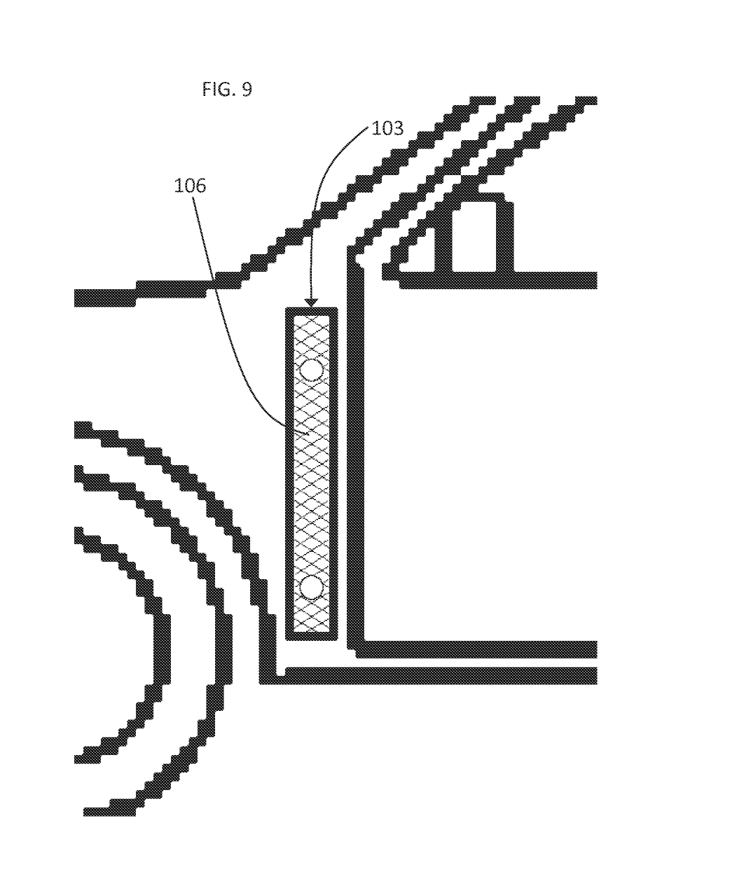

The detection apparatus 1 comprises at least a pair of stereo cameras 2, 3 for acquiring images and a unit 4 for processing the acquired images (see FIG. 7).

The processing unit 4 is configured to perform a rectification, a distortion correction and a disparity calculation on the acquired images.

Preferably, each of the stereo cameras 2, 3 has a CMOS-type sensor 5 (acronym for “Complementary Metal Oxide Semiconductor”). In particular, the stereo cameras 2, 3 have a CMOS Gigabit Ethernet interface.

Alternatively, the sensor 5 of each camera 2, 3 is of the CCD type (acronym for “Charge Coupled Device”).

It is likewise possible to use cameras 2,3 with other communication interfaces, such as firewire, USB or an analog interface. Moreover, the cameras 2, 3 can be colour, grayscale, NIR or thermal cameras.

Since both CMOS and CCD sensors are already known, they will not be further described below.

The sensors 5 acquire the images according to the technique commonly known in the sector by the expression “global shutter”. The global shutter acquisition technique is one in which exposure of all pixels of the image (or frame) takes place simultaneously over the entire acquisition time window. This is unlike the other commonly known technique, i.e. “rolling shutter”, which entails a vertical or horizontal scan of the image (or frame), so that adjacent rows or columns of pixels are exposed at different times, with the risk of distortions of the image under conditions of high vehicle speeds.

Innovatively, the two stereo cameras 2, 3 are installed on one of the two sides I1, I2 of the vehicle 100 at different heights h1, h2 relative to the resting surface P of the vehicle 100, as illustrated in FIG. 8.

The heights h1, h2 of the stereo cameras 2, 3 relative to the resting surface P are measured based on the optical axes O1, O2 of the cameras 2, 3. In the technical field of reference, the distance d between the parallel optical axes O1, O2 is indicated with the term “baseline”. The plane containing the optical axes O1, O2 is perpendicular to the resting surface P.

Advantageously, the detection apparatus 1 comprises a support 6 for the cameras 2, 3, which can be integrated inside the vehicle 100 in proximity to one of the sides I1, I2 thereof.

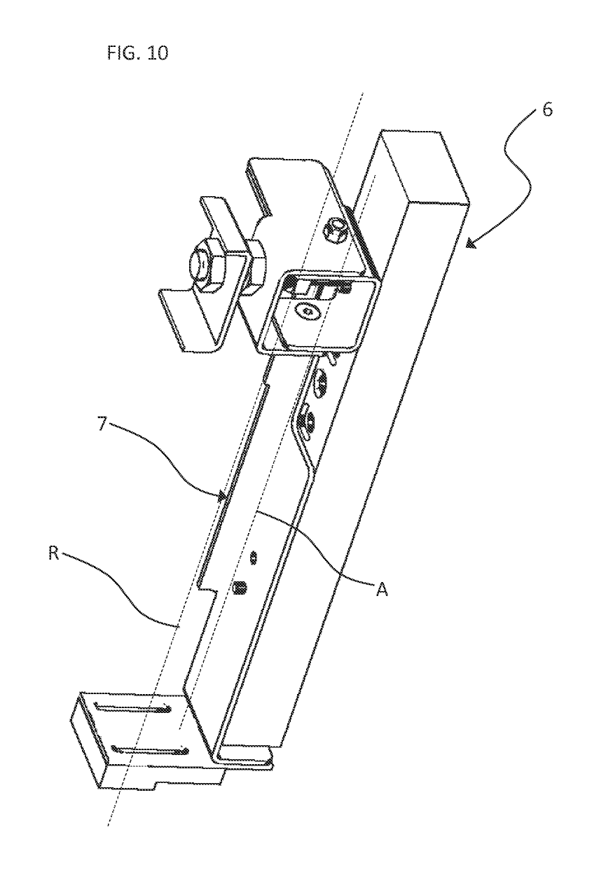

The support 6 comprises a bracket 7 which extends prevalently longitudinally along a pre-established direction A, as illustrated in FIG. 10.

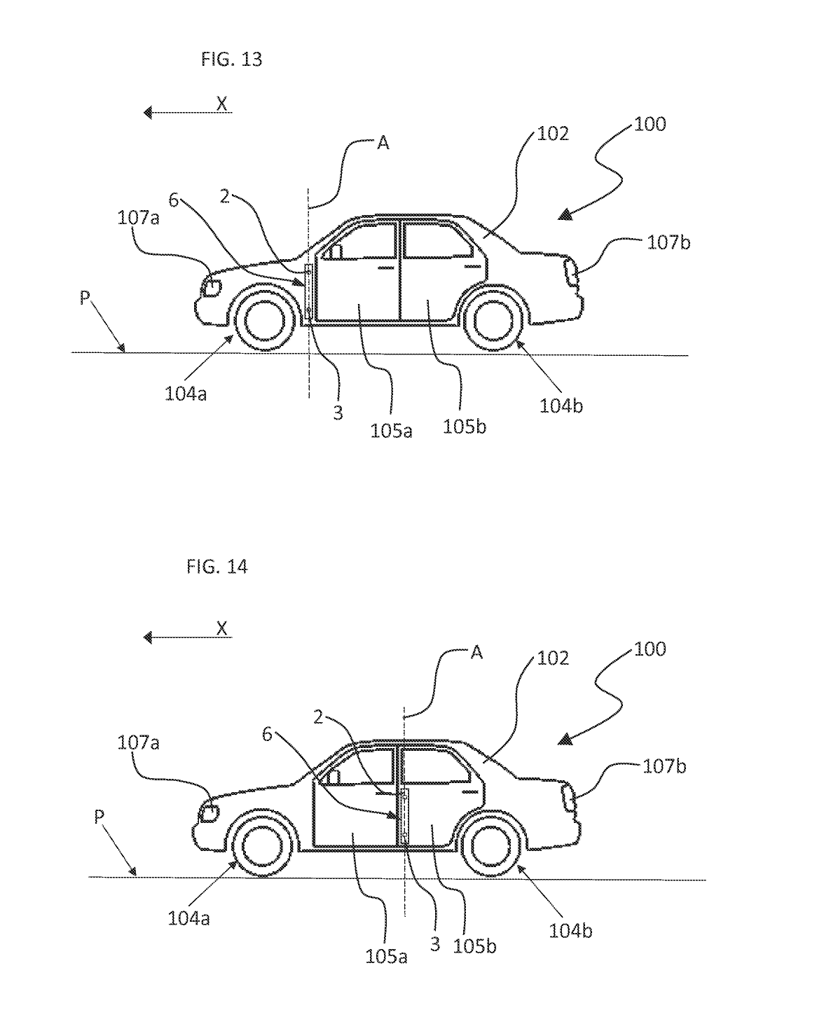

This support 6 is integrated onto the vehicle 100 in such a way that the pre-established direction A is perpendicular to the surface P on which the vehicle 100 itself rests, as illustrated in FIGS. 13 to 16.

In the figures appended here, the resting surface P is horizontal and the pre-established direction A is vertical. Therefore, the cameras 2, 3 are arranged one above the other vertically and the baseline d is likewise vertical.

Preferably, the baseline d is comprised between 100 mm and 500 mm as a function of the specific detection distance required. In fact, the baseline value d influences the detection distance.

As is known, the sensors 5 have a substantially rectangular shape with dimensions a x b.

Advantageously, the sensors 5 of the stereo cameras 2, 3 are mutually coplanar and perpendicular to the resting surface P.

Preferably, the sensors 5 are oriented in such a way as to have the two long sides a of the rectangle lying along a forward travel direction X of the vehicle 100 on the resting surface P. This configuration is illustrated in FIG. 12.

For example, with a sensor 5 having a size of 1/1.8″ and a lens focal length of about 2.5 mm (corresponding to a rectangle of about 6.7840 mm×5.4270 mm), arranged with its long sides according to the direction of forward travel X, a horizontal FOV angle of about 105° is obtained.

In the embodiment described and illustrated here, the spatial orientation of the sensors 5 can be varied by acting on the support 6, as will be explained below.

The support 6 are accommodated in a housing compartment 101 obtained in proximity to one of the sides I1, I2 of the vehicle 100. In particular, the housing compartment 101 is obtained within the vehicle 100.

Innovatively, the bodywork 102 of the vehicle 100 is provided with at least one through opening 103 for access to the housing compartment 101.

Preferably, the through opening 103 consists in a substantially rectangular cut made in the bodywork 102.

In a first embodiment, there is only one through opening 103. In that embodiment, the bodywork 102 presents a single recess 108 obtained in correspondence to the through opening 103 and housing both stereo cameras 2, 3.

For example, the through opening 103 has dimensions that vary as a function of the baseline d and of the size of the cameras 2, 3. Considering an empty space in every direction comprised between 10 mm and 100 mm, an interval of 50-70 mm is obtained for the width and 120-600 mm for the height, whilst the housing compartment 101 occupies a volume comprised between (70-90) mm×(150-700) mm×(30-80) mm. For example, FIG. 13 illustrates the through opening 103 made between the fender of front wheel 104a and front door 105a.

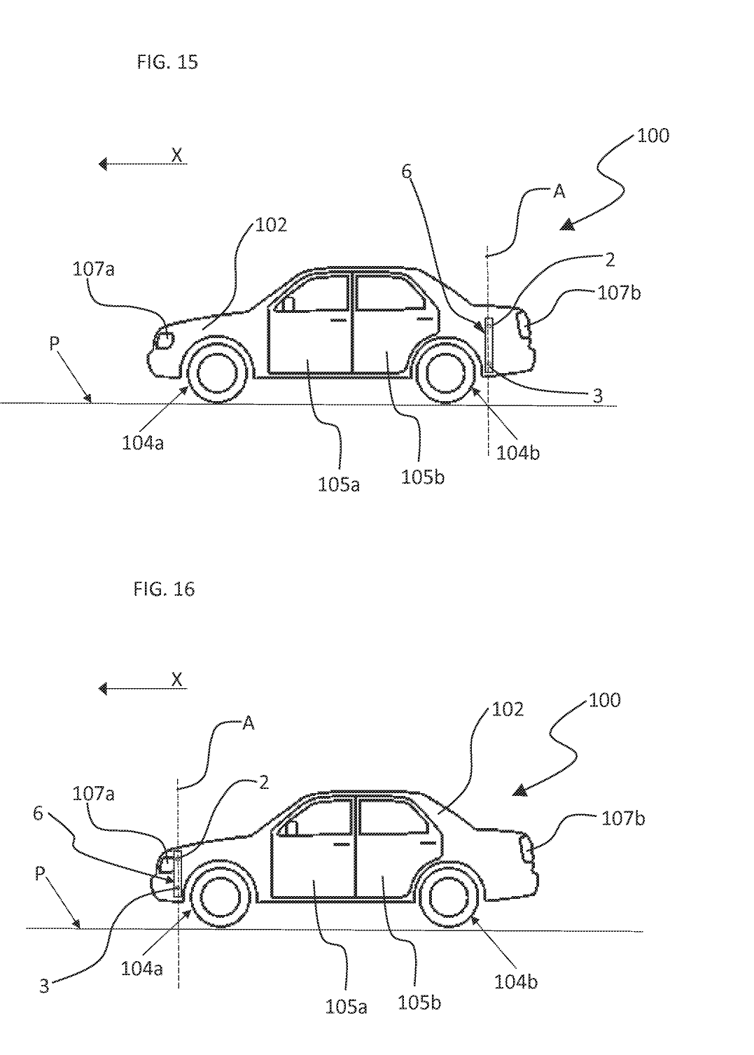

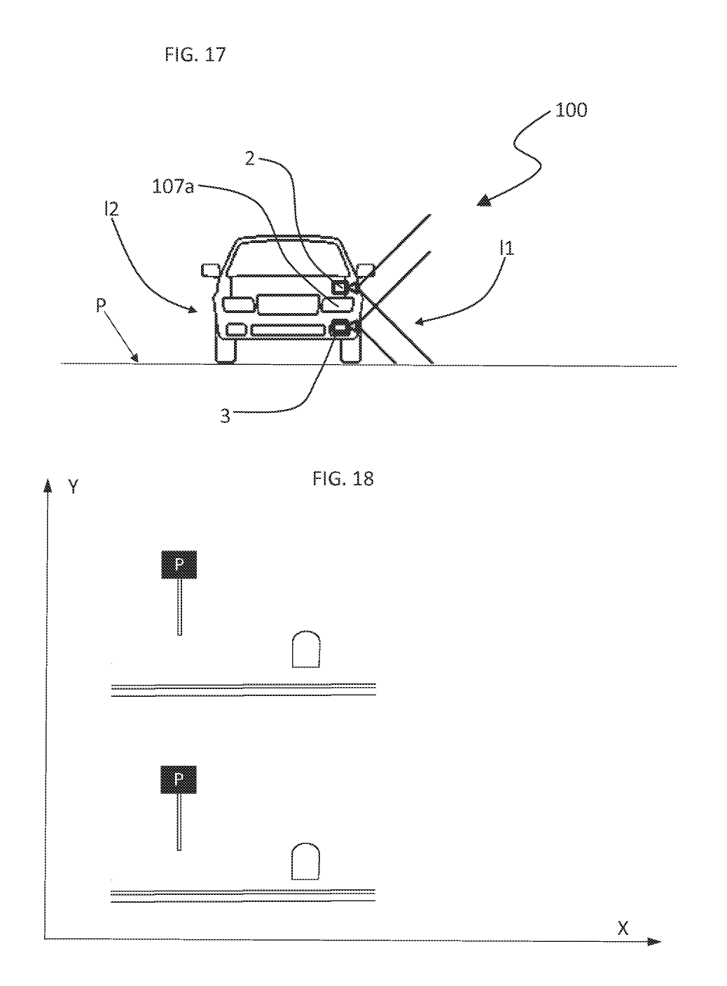

FIG. 15 illustrates the through opening 103 made in proximity to the rear wheel 104b. The through opening 103 can also be made directly in a door, for example, the front door 105a or else the rear door 105b (as illustrated in FIG. 14).

The through opening 103 can also be made in proximity to one of the headlights or tail lights, for example in proximity to a headlight 107a (as illustrated in FIG. 16) or a tail light 107b.

In the first embodiment, a removable grille 106 is applied on the through opening 103 to mask it, while the stereo cameras 2, 3 are hanging-over mounted relative to the grille 106.

In an alternative embodiment (not illustrated), there is envisaged a portion of sheet metal removably applicable to the through opening 103 to mask it.

In a second embodiment, the bodywork 102 presents two through openings 103 for access to the housing compartment 101, which are obtained on the same side I1 of the vehicle 100. The bodywork 102 also presents two recesses 108, each of which is obtained in correspondence to one of the through opening 103. Each recess 108 houses one of the stereo cameras 2, 3.

Preferably, each of the two recesses 108 is substantially shaped as a “drop” with a depth that decreases from the front zone to the rear zone of the vehicle 100.

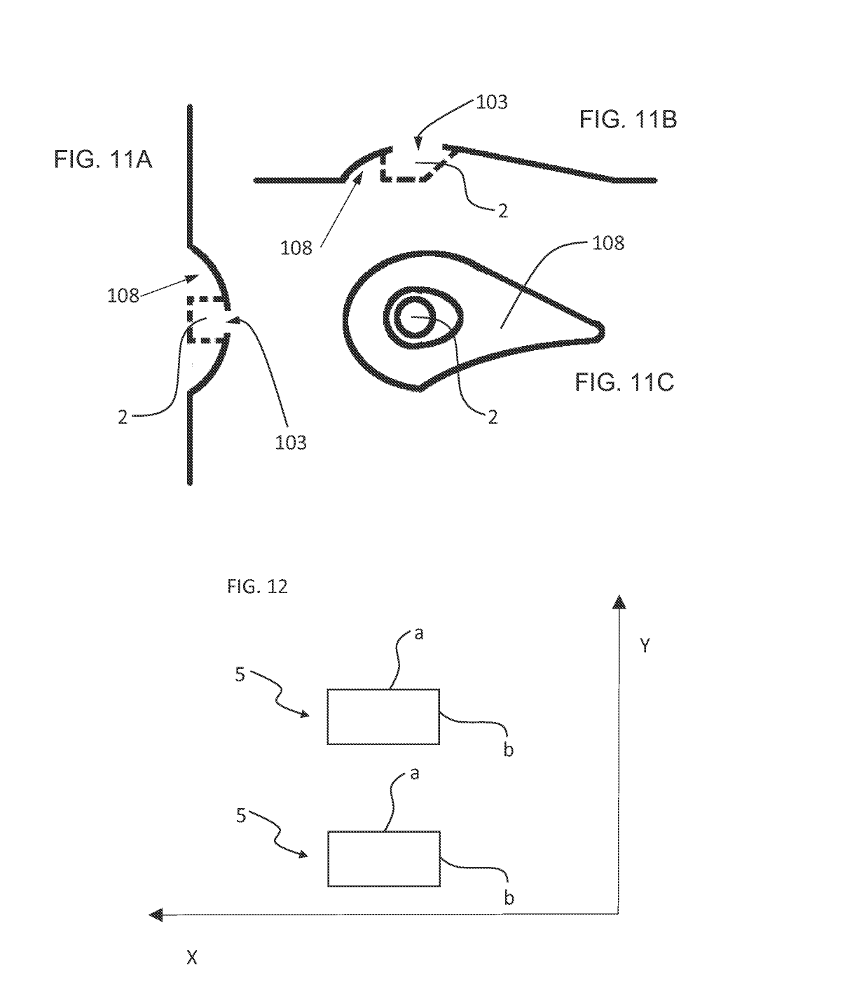

For example, in FIG. 11 there is illustrated one of the two recesses 108, obtained between the fender of the front wheel 104a and the front door 105a. In this case, the depth of the recess 108 decreases according to a gradual profile from the fender of the front wheel 104a to the front door 105a.

Alternative positions of the two recesses 108 are also envisaged, according to what has been illustrated and described for the embodiment with single recess (see FIGS. 13 to 16).

In the embodiments described and illustrated here, the support 6 is rotatably pivoted on the bodywork 102 in such a way as to rotate around a rotation axis R parallel to the pre-established direction A in order to vary the overall orientation of the pair of stereo cameras 2, 3.

In the second embodiment, the rotation angle of the support 6 is more limited than in the first embodiment due to the drop shaping of the recesses 108. However, the variation of the yaw angle of the cameras 2, 3 can be increased by enlarging the volume of the recesses 108.

In an unillustrated variant embodiment, the support 6 is mounted on the bodywork 102 in a fixed position (i.e. it is not adjustable). In this case as well, the sensors 5 have the long sides a of the rectangle lying along the direction of forward travel X of the vehicle 100 on the resting surface P.

Preferably, the detection apparatus 1 comprises two pairs of stereo cameras 2, 3, respectively placed on one side I1 and on the other side I2 of the vehicle 100.

Also envisaged is the possibility of having a plurality of pairs of stereo cameras 2, 3 for each side I1, I2 of the vehicle 100.

The operation of the lateral obstacle detection apparatus for a motor vehicle according to the present invention is described below.

During the forward travel of the vehicle 100 along the direction of forward travel X, the sensors 5 of the two stereo cameras 2, 3 acquire two images, a lower image and an upper image, illustrated in FIG. 18.

In order to process the images, the two-dimensional reference system selected is the one having the direction of forward travel X as the abscissa and a straight line perpendicular to the optical axes O1, O2 of the cameras 2, 3 as the ordinate.

Since the cameras 2, 3 are arranged at different heights h1, h2 and the optical axes O1, O2 are aligned, i.e. the plane containing them is perpendicular to the resting surface P, the two images equally extend along the abscissa X. The processing unit 4 thus calculates the disparity as the difference in position of a significant element along the ordinate Y. In other words, the disparity is calculated as the difference between the lines.

Preferably, the disparity is calculated by means of an algorithm of a known type based on SGM (acronym of “Semi-Global Matching”). Alternatively, another type of dense or non-dense stereo algorithm can be employed.

Since it is not possible to achieve a perfect perpendicular alignment of the cameras 2, 3 relative to the resting surface P, the processing unit 4 performs a rectification of the acquired images. The rectification takes places according to known algorithms or combinations of known algorithms. For example, the rectification comprises a roto-translation and stretching of the acquired images.

Finally, the lenses present in the cameras 2, 3 introduce distortions that are corrected by the processing unit 4.

The rectification and distortion correction can take place simultaneously thanks to the use of a so-called “look-up table”, i.e. a table that associates a rectified and distortion-corrected position with each position of the original image.

Based on the description made, the features of a lateral obstacle detection apparatus for a motor vehicle, a motor vehicle comprising that apparatus and a process for detecting lateral obstacles during the travel of a motor vehicle, according to the present invention, appear clearly evident, as do the advantages thereof.

In particular, the positioning of the stereo cameras on the vehicle according to a vertical baseline, i.e. at different heights diverse relative to the surface on which the vehicle rests, together with the arrangement of the sensors on the same plane perpendicular to the surface on which the vehicle rests, enables the lateral area sensed by the apparatus to be maximized.

Moreover, the arrangement of the sensors with the long sides in the direction of forward travel of the vehicle enables the horizontal field of view to be increased.

For example, with a field of view of about 100° and a baseline of about 300 mm, it is possible to locate obstacles situated at a distance of about 1 m with a precision of about 1 cm and obstacles situated at a distance of about 18 m with a precision of about 1 m.

Moreover, it is possible to identify obstacles up to about 30 m.

Moreover, the variant embodiment with a rotatable support enables the overall orientation of the pair of stereo cameras (or sensors) to be adjusted according to the area of interest to be framed.

Furthermore, the use of the global shutter technique to acquire the images makes it possible for the apparatus to work well even under conditions of high vehicle speeds (above 30 km/h for example). In fact, since all the pixels are simultaneously exposed, the captured image is substantially free of distortions.

Maintenance of the detection apparatus can be easily performed thanks to the direct access to the cameras via the opening made in the bodywork.

The reliability and compactness of the proposed detection apparatus, mounted on board the motor vehicle, is tied to the housing of the cameras and the support thereof inside a compartment fashioned in the vehicle.

Moreover, the embodiment with two recesses shaped as a “drop” in the bodywork originates an air displacement during the travel of the vehicle that removes the dust from the optical units (dust, sand, earth, water, mud raised by the preceding vehicle, etc.). The arrangement of the optical units inside the recess do not affect the field of view.

The aesthetic impact of the opening providing access to the compartment is masked thanks to the grille or portion of removable sheet metal and the fact that the pair of cameras has a substantially vertical orientation relative to the prevalently horizontal extension of the side of the vehicle.

The proposed apparatus thus enables lateral obstacles to be accurately detected also under low-light conditions.

1. Lateral obstacle detection apparatus for a motor vehicle, comprising:
at least one pair of stereo cameras for acquiring images;
a unit for processing the acquired images,
characterized in that it comprises a support for said stereo cameras, said support having an elongated shape and extending prevalently along a pre-established direction that is substantially perpendicular to a surface on which the vehicle rests, said stereo cameras being mounted on the support at different heights relative to said resting surface and comprising coplanar sensors arranged perpendicularly to the resting surface.

2. Detection apparatus according to claim 1, wherein the sensors of said cameras are substantially rectangular and oriented in such a way as to have the longer sides lying along a direction of forward travel of the vehicle on said resting surface.

3. Detection apparatus according to claim 1, wherein said sensors are of the CMOS or CCD type.

4. Detection apparatus according to claim 1, wherein said sensors acquire the images according to the global shutter technique.

5. Detection apparatus according to claim 1, wherein the height difference between said cameras is comprised between 100 mm and 500 mm.

6. Detection apparatus according to claim 1, wherein the processing unit is configured to perform a rectification, a distortion correction and a disparity calculation on the acquired images.

7. Motor vehicle comprising:
a lateral obstacle detection apparatus according to claim 1;
a compartment for housing said support, said housing compartment being obtained in proximity to a side of the vehicle, said support being arranged in the housing compartment in such a way that said pre-established direction is substantially perpendicular to the surface on which the vehicle rests;
a bodywork provided, on said side, with at least one through opening for access to said housing compartment.

8. Motor vehicle according to claim 7, wherein said support is rotatably pivoted on the bodywork so as to rotate around a rotation axis parallel to said pre-established direction in order to vary the overall orientation of the pair of stereo cameras.

9. Motor vehicle according to claim 7, wherein said at least through opening consists in a substantially rectangular cut made in the bodywork of the vehicle.

10. Motor vehicle according to claim 7, wherein said at least through opening is made between the fender of the front wheel and the front door.

11. Motor vehicle according to claim 7, wherein said at least a through opening is made in proximity to the rear wheel.

12. Motor vehicle according to claim 7, wherein said at least a through opening is made in a door.

13. Motor vehicle according to claim 7, wherein said at least a through opening is made in proximity to one of the lights.

14. Motor vehicle according to claim 7, wherein said bodywork presents a single recess obtained in correspondence to said through opening and housing said stereo cameras.

15. Motor vehicle according to claim 14, further comprising a grille removably applied on said through opening to mask it, said cameras being hanging-over mounted relative to the grille.

16. Motor vehicle according to claim 7, wherein said bodywork presents two through openings for access to said housing compartment, which are obtained on the same side of the vehicle, and two recesses obtained in correspondence to each of said through openings, each of said recesses housing one of the stereo cameras.

17. Motor vehicle according to claim 16, wherein each of said recesses is substantially shaped as a “drop” with a depth that decreases from the front zone to the rear zone of the vehicle.

18. Process for detecting lateral obstacles during the travel of a motor vehicle in a direction of forward travel on a resting surface, comprising the following steps:
arranging a pair of stereo cameras at different heights relative to the resting surface inside a housing compartment in proximity to a side of the vehicle itself;
periodically acquiring frames of the lateral area of the vehicle by means of said stereo cameras;
processing the acquired images to pinpoint the position of the lateral obstacles.
